(19) United States
(12) Patent Application Publication
(10) Pub. No.: US 2014/0092883 A1
(43) Pub. Date: Apr. 3, 2014

(54) METHOD AND SYSTEM FOR ASSIGNING SLOT RESERVATIONS TO SUBSCRIBER RADIOS IN A TELECOMMUNICATIONS SYSTEM

(71) Applicant: MOTOROLA SOLUTIONS, INC., Schaumburg, IL (US)

(72) Inventors: SANJAY G. DESAI, LAKE IN THE HILLS, IL (US); ALAN P. CONRAD, GENEVA, IL (US); ROBERT D. LOGALBO, ROLLING MEADOWS, IL (US)

(73) Assignee: MOTOROLA SOLUTIONS, INC., Schaumburg, IL (US)

(21) Appl. No.: 13/631,576

(22) Filed: Sep. 28, 2012

(51) Int. Cl. H04W 72/04

(52) U.S. Cl. 370/337

(57) ABSTRACT

A method for assigning slot reservations to subscriber radios in a TDMA communications system, where data is arranged into a series of superframes, includes an inbound signaling protocol having a plurality of inbound transmission slots. An outbound signaling protocol includes an inbound reservation scheduling slot, which includes a plurality of subscriber access code fields. Each subscriber access code field corresponds to at least one of the inbound transmission slots. Each subscriber access code field may store a subscriber access code associated with a subscriber radio. The inbound reservation scheduling message includes a subscriber access code in at least one of the subscriber access code fields. As such, the subscriber radio associated with the subscriber access code may transmit data during the inbound transmission slot corresponding to the subscriber access code in which the subscriber access code field is stored.

### FIELD OF THE DISCLOSURE

The present disclosure relates generally to telecommunications systems and more particularly to a method of assigning transmission slot reservations to subscriber radios in a telecommunications system.

### BACKGROUND

Time division multiple access (TDMA) communications systems and associated methods are commonly utilized for two-way radio communications between a base station and subscriber radios. These systems and methods utilize multiple superframes of data divided into a plurality of inbound slots for subscriber radios to transmit data to the base station. The inbound slots may further be differentiated into multiple logical channels.

However, contemporary TDMA systems and associated methods have various inefficiencies. For instance, the assigning of the inbound slots to the subscriber radios has been rudimentary. Specifically, in conventional trunked radio systems, a single inbound slot is assigned to a subscriber radio in a single superframe.

Accordingly, there is a need for an improved system and method that overcomes the deficiencies of existing TDMA systems.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of a communication system 100 in accordance with some embodiments.

FIG. 2 is a graphical representation of inbound and outbound slot sequences of a plurality of superframes in accordance with some embodiments.

FIG. 3 is a graphical representation of an inbound reservation scheduling slot in accordance with some embodiments.

FIG. 4 is a chart showing the inbound transmission slots associated with the reservation scheduling slots of one superframe in accordance with some embodiments.

FIG. 5 is a graphical representation of a reservation request response in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The system and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

A method of assigning slot reservations to subscriber radios in a time division multiple access (TDMA) communications system is described herein. Transmission of data in the system is arranged into a series of superframes. The method includes providing an inbound signaling protocol transported in a plurality of inbound transmission slots. The method also includes providing an outbound signaling protocol. The outbound signaling protocol includes an inbound reservation scheduling message, which includes a plurality of subscriber access code fields. Each subscriber access code field corresponds to at least one of the plurality of inbound transmission slots. Each subscriber access code field is also able to store a subscriber access code associated with a subscriber radio. The method further includes transmitting the inbound reservation scheduling message within an inbound reservation scheduling slot. The inbound reservation scheduling message includes a subscriber access code in at least one of the subscriber access code fields. As such, the subscriber radio associated with the subscriber access code may transmit data during the at least one of the inbound transmission slots corresponding to the subscriber access code field in which the subscriber access code is stored.

A method of operating a time division multiple access (TDMA) communications system is also described herein. The system includes a base station and at least one subscriber radio. Encoded data is mapped to a protocol, i.e., a message format, and the protocol is mapped to a plurality of TDMA time slots. The TDMA time slots are then arranged into a series of superframes. The method includes receiving data in accordance with an inbound signaling protocol transported in a plurality of inbound transmission slots. The method further includes transmitting data in accordance with an outbound signaling protocol. The outbound signaling protocol includes an inbound reservation scheduling message, wherein the inbound reservation scheduling message includes a plurality of subscriber access code fields. Each subscriber access code field corresponds to at least one of the plurality of inbound transmission slots. Each subscriber access code field is able to store a subscriber access code associated with a subscriber radio. The method further includes transmitting the inbound reservation scheduling message within an inbound reservation scheduling slot. The inbound reservation scheduling message includes a subscriber access code in at least one of the subscriber access code fields. As such, the subscriber radio associated with the subscriber access code may transmit data during the at least one of the inbound transmission slots corresponding to the subscriber access code field in which the subscriber access code is stored.

The TDMA communications system is also described herein. Transmission of data in the system is arranged into a series of superframes. The system includes a controller capable of receiving an inbound signaling protocol transported in a plurality of inbound transmission slots. The controller is also capable of providing an outbound signaling protocol having an inbound reservation scheduling message. The inbound reservation scheduling message includes a plurality of subscriber access code fields. Each subscriber access code field corresponds to at least one of the plurality of inbound transmission slots. Each subscriber access code field is able to store a subscriber access code associated with a subscriber radio. The system also includes a transmitter in communication with the controller for transmitting inbound reservation scheduling messages within an inbound reservation scheduling slot. The inbound reservation scheduling message includes a subscriber access code in at least one of the subscriber access code fields. As such, the subscriber radio associated with the subscriber access code may transmit data during the at least one of the inbound transmission slots corresponding to the subscriber access code field in which the subscriber access code is stored.

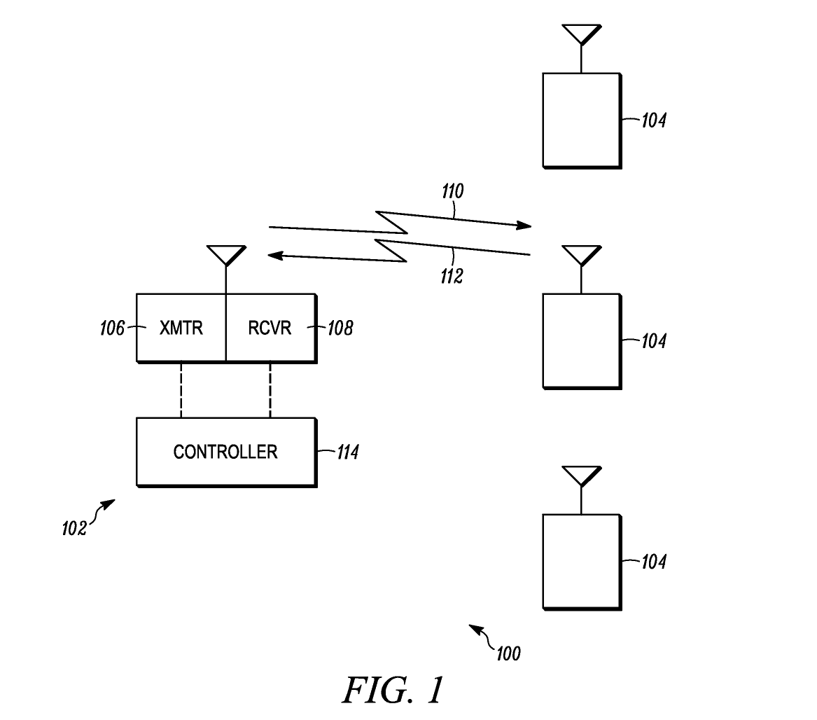

FIG. 1 is a block diagram of the system 100 according to one embodiment. The system 100 includes at least one base station 102 and at least one subscriber radio 104. In FIG. 1, the system is shown with a single base station 102 and a plurality of subscriber radios 104. However, the system 100 may include any number of base stations 102 and subscriber radios 104, as readily appreciated by those skilled in the art.

The system 100 of the illustrated embodiment uses a frequency domain duplex (“FDD”) configuration, i.e., the system 100 utilizes at least one inbound frequency and at least one outbound frequency. More specifically, the system 100 of the illustrated embodiment utilizes a FDD control channel, a plurality of FDD voice channels, and a plurality of FDD data channels. That is, the system 100 utilizes two frequencies for the control channel, two frequencies for each voice channel, and two frequencies for each data channel. Of course, any number of control channels, voice channels, and/or data channels may be utilized. The data channel of the illustrated embodiment is referred to as an enhanced data capacity (“EDC”) channel. Furthermore, those skilled in the art recognize that digital encoding for “data” may be utilized on each control channel, voice channel, and/or data channel. Also, in the illustrated embodiment, the control channel, the voice channels, and the data channels are synchronized to a common clock (not shown).

The base station 102 of the illustrated embodiment is full-duplex, i.e., the base station may transmit on one frequency and receive on another frequency simultaneously. The subscriber radios 104 of the illustrated embodiment are half-duplex, i.e., the subscriber radios 104 cannot transmit and receive at the same time. Of course, in other embodiments, the duplexing of the base station 102 and/or subscriber radios 104 may be different.

The base station 102 includes a transmitter 106 and a receiver 108. The transmitter 106 and receiver 108 may be combined together as a transceiver (not shown) as is well appreciated by those skilled in the art. The transmitter 106 is capable of transmitting at least one radio frequency (RF) signal 110 and the receiver 108 is capable of receiving at least one RF signal 112. Likewise, each subscriber radio 104 also includes a transmitter (not shown) and a receiver (not shown), which may be combined as a transceiver. The transmitter and receiver of the subscriber radios 104 are also capable of transmitting and receiving RF signals 112, 110.

Digital data (not shown) may be encoded on the RF signals 110, 112. In the illustrated embodiment, data is encoded using TDMA techniques well known to those skilled in the art. However, in other embodiments, other techniques may be used to encode the data, as appreciated by those skilled in the art. These techniques include, but are certainly not limited to, frequency division multiple access (FDMA) techniques and code division multiple access (CDMA) techniques. The base station 102 also includes at least one antenna (not numbered) electrically connected to the transmitter 106 and/or the receiver 108 for transmitting and/or receiving RF signals 110, 112. Of course, the subscriber radios 104 also include at least one antenna (not numbered) electrically connected to the transmitter and/or receiver for transmitting and/or receiving RF signals 110, 112.

The transmitter 106 and receiver 108 are in communication with the controller 114. As such, the controller 114 may provide the data to be transmitted via the RF signal 110 to the transmitter 106. Similarly, the controller 114 may receive the data received via the RF signal 112 from the receiver 108. The controller 114 may include one or more microprocessors (not shown) or other computing devices capable of executing instructions and/or storing data as is appreciated by those skilled in the art. Furthermore, the controller 114 of the illustrated embodiment is capable of executing the steps of the methods described herein. The controller 114 may be implemented as part of the base station 102 or may be remote from the base station 102. Furthermore, the controller 114 may be in communication with multiple transmitters 106 and/or receivers 108 of multiple base stations 102.

In the illustrated embodiment, each subscriber unit 104 may tune its receiver to receive an RF signal being transmitted by the base station 102 on the control channel. This RF signal encodes information including, but not limited to, the frequencies of the voice and EDC channels, which voice and EDC channels are in use, and/or which voice and EDC channels are available. Based on this information, the subscriber unit 104 may then tune its transmitter and/or receiver to other voice or EDC channels (i.e., frequencies). Of course, each subscriber unit 104 may return to tune its receiver to the control channel at various times to check for announcements or group calls relevant to the subscriber unit 104.

Protocols, methods, and operation of the at least one EDC channel of the illustrated embodiment is described in greater detail below. However, those skilled in the art appreciate that these teachings may be applied to other channels and or different systems not specifically described herein.

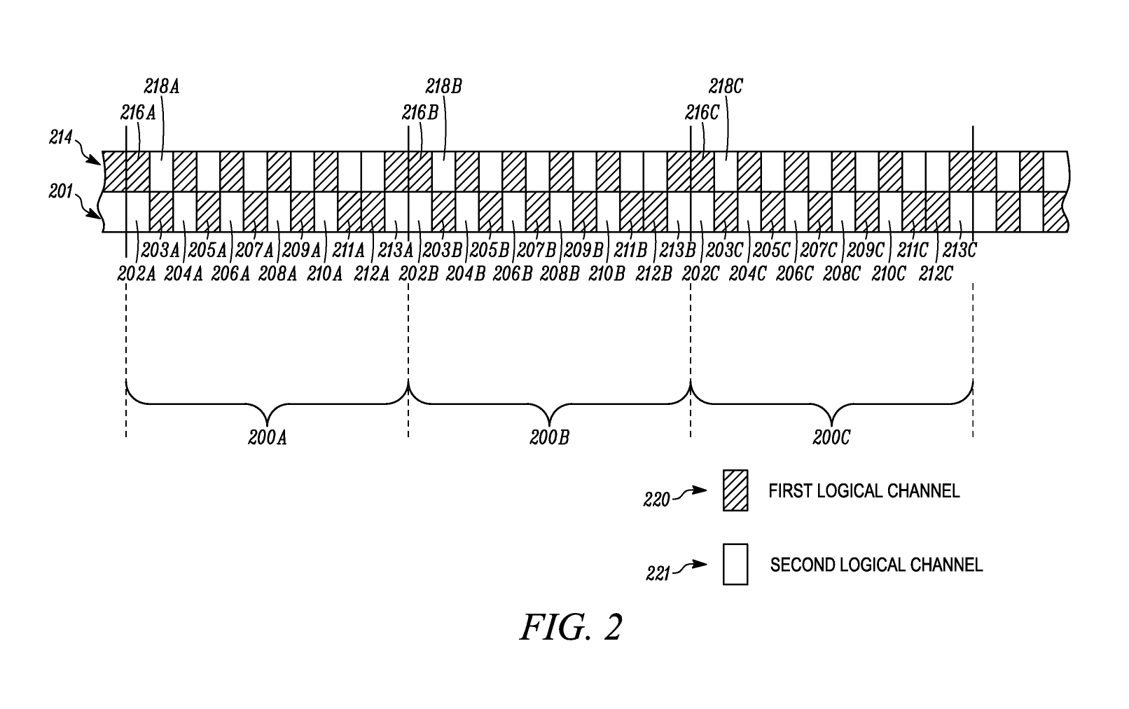

Transmission of data between the base station 102 and the subscriber radios 104 on the at least one EDC channel is arranged into a series of superframes. Specifically, FIG. 2 shows a first superframe 200A, a second superframe 200B, and a third superframe 200C. However, those skilled in the art realize that superframes of data are continuously transmitted, and the three superframes 200A, 200B, 200C are for exemplary purposes only.

The method may be implemented using the embodiment of the system 100 described herein. However, the method as set forth above and in the claims may be implemented using other systems and embodiments than those specifically recited herein.

As stated above, the method includes providing an inbound signaling protocol (not numbered). The inbound signaling protocol of the illustrated embodiment is transported within inbound random access slots (not shown) and inbound reserved access slots 201, as shown in FIG. 2. A subscriber radio 104 may transmit during an inbound random access slot. Furthermore, the assigning of one or more of the inbound reserved access slots 201 to a subscriber radio 104 is achieved by that subscriber radio 104 making a request in one of the inbound random access slots, as described in greater detail below.

The term “slot” as used herein refers generally to a time period dedicated to a specific burst transmission of energy which signals a message, address, protocol, data, voice, media, etc. However the term “slot” may ubiquitously refer to that actual specific transmission of energy which signals a message, address, protocol, data, voice, media, etc. which occurs within that specific time period.

The inbound reserved access slots 201 are referred to hereafter as simply the inbound transmission slots 201. The inbound transmission slots 201 of the EDC channels may accommodate data, voice, or simultaneous voice and data.

In the illustrated embodiment, there are twelve inbound transmission slots 202-213 in each superframe numbered consecutively from a first inbound transmission slot 202 to a twelfth inbound transmission slot 213. Each inbound transmission slot 202-213 defines a time period at which subscriber radios 104 may transmit to the base station 102. In the illustrated embodiment, the inbound signaling protocol may be referred to as an inbound media access control (“MAC”) layer protocol.

The inbound transmission slots 202-213 may be labeled in the figures and herein with a suffix matching the suffix of the superframe. For example, the inbound transmission slots 202-213 of the first superframe 200A are labeled from 202A-213A in FIG. 2.

The inbound transmission slots 201 which transport the inbound signaling protocol may be associated with either a first logical channel 220 or a second logical channel 221. In the illustrated embodiment, some of the inbound transmission slots 202-213 are associated with the first logical channel 220 and some are associated with the second logical channel 221. Specifically, inbound transmission slots 203, 205, 207, 209, 211, 212 are associated with the first logical channel 220 and inbound transmission slots 202, 204, 206, 208, 210, 213 are associated with the second logical channel 221.

The logical channels 220, 221 may be differentiated by the type of data that the corresponding inbound transmission slots 202-213 carry. For example, the first logical channel 220 may carry voice data while the second logical channel 221 may carry other data.

The method also includes providing an outbound signaling protocol (not numbered). In the illustrated embodiment, the outbound signaling protocol may be referred to as an outbound MAC layer protocol. The outbound signaling protocol of the illustrated embodiment is transported in outbound transmission slots 214 as shown in FIG. 2. The outbound transmission slots 214 which transport the outbound signaling protocol may also be associated with either the first logical channel 220 or the second logical channel 221.

The outbound transmission slots 214 include at least one inbound reservation scheduling slot 216, 218. For example, in the illustrated embodiment, each superframe 200A, 200B, 200C includes a first inbound reservation scheduling slot 216A, 216B, 216C and a second inbound reservation scheduling slot 218A, 218B, 218C.

In the illustrated embodiment, each first inbound reservation scheduling slot 216 carries an inbound reservation schedule for the first logical channel 220 of part the current superframe and part of the next superframe. Furthermore, each second inbound reservation scheduling slot 218 carries an inbound reservation schedule for the second logical channel 221 of part of the current superframe and part of the next superframe. As such, and for example, in the first superframe 200A, the first inbound reservation scheduling slot 216A carries the reservation schedule for the first logical channel 220 of part of the first superframe 200A and part of the second superframe 200B. Similarly, the second inbound reservation scheduling slot 218A carries the reservation schedule for the second logical channel 221 of part the first superframe 200A and part of the second superframe 200B.

In an alternative embodiment, in which a full-duplex subscriber radio 104 is utilized, each first inbound reservation scheduling slot 216 carries a reservation schedule for the first logical channel 220 of the current superframe and each second inbound reservation scheduling slot 218 carries a reservation schedule for the second logical channel 221 of the current superframe. As such, in the first superframe 200A, the first inbound reservation scheduling slot 216A and the second inbound reservation scheduling slot 218A carry the reservation schedule for the first logical channel 220 and the second logical channel 221, respectively, of the first superframe 200A

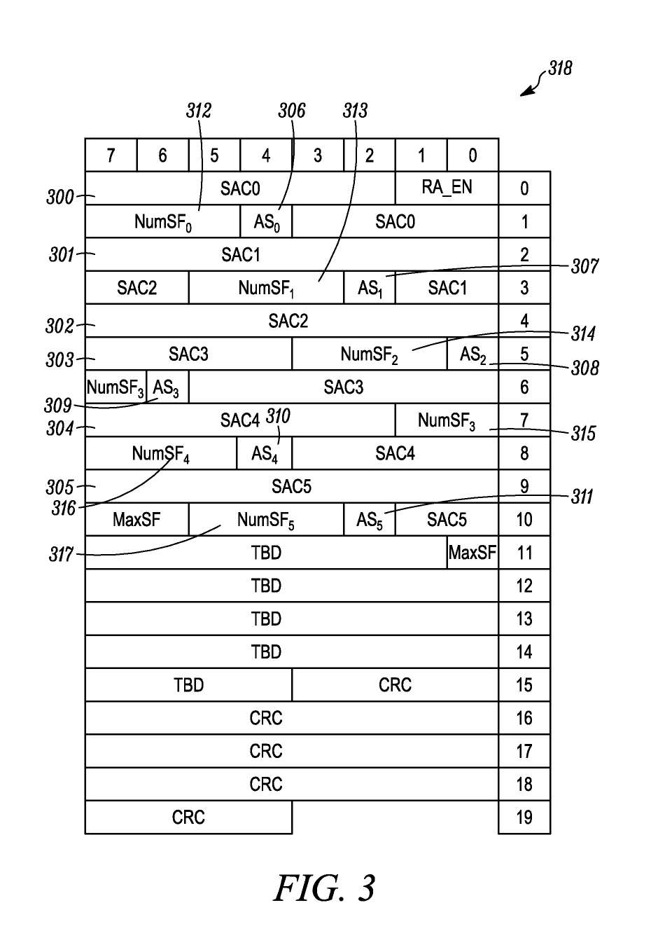

Referring now to FIG. 3, an inbound reservation schedule is signaled using an inbound reservation scheduling message 318 transported in an inbound reservation scheduling slot 216, 218. Each inbound reservation scheduling message 318 includes a plurality of subscriber access code fields 300, 301, 302, 303, 304, 305. Each subscriber access code field 300-305 is able to store a subscriber access code (not shown) associated with a subscriber radio 104. A subscriber access code is a temporary address used to identify each subscriber radio 104. The subscriber access codes fields 300-305 in the illustrated embodiment are each 10-bits in length to accommodate subscriber access codes up to 10 bits. However, other lengths for the subscriber access codes and subscriber access code fields 300-305 may be utilized in other embodiments. The subscriber access code is assigned by the base station 102 in response to a request from the subscriber radio 104 in one of the inbound random access slots. The request for the subscriber radio 104 may utilize a full 24-bit, 32-bit, or larger subscriber address. The smaller (e.g., 10-bit) subscriber access code is utilized to conserve message bits during the life of the reservation. The base station 102 maps the full subscriber address to the assigned subscriber access code such that each subscriber radio 104 identifies which subscriber access code has been assigned to it. This mapping of full subscriber address to subscriber access code serves as an acknowledgement that the subscriber's reservation request on the random access channel was received by the base station 102. Using the smaller subscriber access code, instead of the full subscriber address, frees up more bits which can then be dedicated to transporting payload media or other supporting signaling on either or both the inbound and outbound EDC channel. Payload throughput conservation is especially vital for a narrowband, low rate system, because the bit rate is constrained.

In the illustrated embodiment, each inbound reservation scheduling message 318 includes a first subscriber access code field 300, a second subscriber access code field 301, a third subscriber access code field 302, a fourth subscriber access code field 303, a fifth subscriber access code field 304, and a sixth subscriber access code field 305. Each subscriber access code field 300-305 corresponds to at least one of the plurality of inbound transmission slots 202-213.

In the illustrated embodiment, at least one of the subscriber access code fields 300-305 corresponds to one of the inbound transmission slots 202-213 in the current superframe.

Also, at least one of the subscriber access code fields 300-305 corresponds to one of the inbound transmission slots 202-213 in the next superframe. For example, when the inbound reservation scheduling message 318 is transported in inbound reservation scheduling slot 216A, 218A in the first superframe 200A, at least one of the subscriber access code fields 300-305 corresponds to one of the inbound transmission slots 202B, 203B, 204B in the second superframe 200B. Likewise, when the inbound reservation scheduling message 318 is transported in the inbound reservation scheduling slot 216B, 218B in the second superframe 200B, at least one of the subscriber access code fields 300-305 corresponds to one of the inbound transmission slots 202C, 203C, 204C in the third superframe 200C.

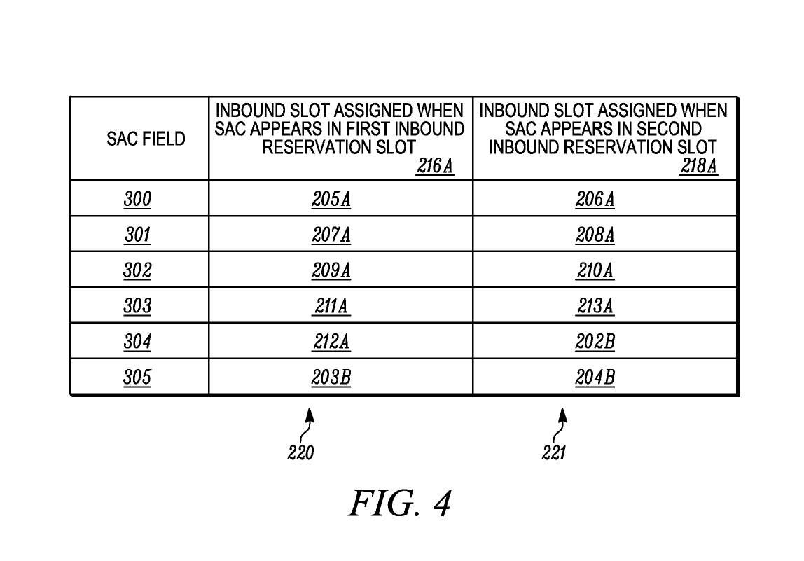

More specifically, FIG. 4 shows a table detailing the inbound transmission slots 203-213 associated with the subscriber access code fields 300-305 of the inbound reservation scheduling message 318 for the illustrated embodiment. The left column lists the various subscriber access code fields 300-305. The middle column represents the inbound transmission slots 205A, 207A, 209A, 211A, 212A, 203B that are assigned when a subscriber access code appears in the various subscriber access code fields 300-305 of the inbound reservation scheduling message 318 transported in the first inbound reservation scheduling slot 216A. The inbound transmission slots 205A, 207A, 209A, 211A, 212A, 203B of the middle column are associated with the first logical channel 220. Similarly, the right column represents the inbound transmission slots 206A, 208A, 210A, 213A, 202B, 204B that are assigned when a subscriber access code appears in the various subscriber access code fields 300-305 of the inbound reservation scheduling message 318 transported in the second inbound reservation scheduling slot 218A. The inbound transmission slots 206A, 208A, 210A, 213A, 202B, 204B of the right column are associated with the second logical channel 221.

For example, if a subscriber access code of a subscriber radio 104 appears in the third subscriber access code field 302 of the inbound reservation scheduling message 318 transported in the first inbound reservation scheduling slot 216A of the first superframe 200A, then the subscriber radio 104 associated with that subscriber access code may transmit during the eighth inbound transmission slot 209A during the first superframe 200A, i.e., the current superframe. As another example, if a subscriber access code of a subscriber radio 104 appears in subscriber access code field 305 of the inbound reservation scheduling message 318 transported in the second inbound reservation scheduling slot 218A of the first superframe 200A, then the subscriber radio 104 associated with that subscriber access code may transmit during the third inbound transmission slot 204B of the second superframe 200B, i.e., the next superframe.

Each inbound reservation scheduling message 318 may also include an adjacent slot bit 306-311 associated with each subscriber access code field 300-305. Specifically, a first adjacent slot bit 306 is associated with the first subscriber access code field 300, a second adjacent slot bit 307 is associated with the second subscriber access code field 301, a third adjacent slot bit 308 is associated with the third subscriber access code field 302, a fourth adjacent slot bit 309 is associated with the fourth subscriber access code field 303, a fifth adjacent slot bit 310 is associated with the fifth subscriber access code field 304, and a sixth adjacent slot bit 311 is associated with the sixth subscriber access code field 305.

In the illustrated embodiment, the adjacent slot bit indicates whether the subscriber radio 104 may also transmit data during the inbound transmission slot 202-213 immediately adjacent to the inbound transmission slot 202-213 corresponding with the subscriber access code field 300-305. The adjacent inbound transmission slot 202-213 may be immediately preceding or following the inbound transmission slot 202-213 corresponding with the subscriber access code field 300-305, dependent on whether the inbound transmission slot 202-213 is scheduled in the first or second inbound reservation scheduling slot 216, 218.

For example, when a subscriber access code of a subscriber radio 104 is stored in the first subscriber access code field 300 and the first adjacent slot bit 306 is set, then that subscriber radio 104 may transmit during the fourth inbound transmission slot 205 and the fifth inbound transmission slot 206 when the inbound reservation scheduling message 318 is transported in the first inbound reservation scheduling slot 216. Similarly, when a subscriber access code of a subscriber radio 104 is stored in the first subscriber access code field 300 and the first adjacent slot bit 306 is set, then that subscriber radio 104 may transmit during the fourth inbound transmission slot 205 and the fifth inbound transmission slot 206 when the inbound reservation scheduling message 318 is transported in the second inbound reservation scheduling slot 218.

Of course, the prior examples are illustrative of only when the subscriber access code is stored in the first subscriber access code field 300. It follows that when other subscriber access code fields 301-305 are utilized in concert with the other associated adjacent slot bits 307-311, the adjacent inbound transmission slots utilized will differ from those described in the previous examples. As such, the subscriber radio 104, of the previous example, may transmit during the third inbound transmission slot 204 and the fourth inbound transmission slot 205 or the fifth inbound transmission slot 206 and the sixth inbound transmission slot 207 depending on whether the inbound reservation scheduling message 318 is transported in the first or second inbound reservation scheduling slot 216, 218.

In an alternative embodiment, the adjacent slot bit may indicate whether the subscriber radio 104 may also transmit data during multiple inbound transmission slots 202-213 immediately adjacent to the inbound transmission slot 202-213 corresponding with the subscriber access code field 300-305. For example, when a subscriber access code of a subscriber radio 104 is stored in the first subscriber access code field 300 and the first adjacent slot bit 306 is set, then that subscriber radio 104 may transmit during the third, fourth and fifth inbound transmission slots 204-206 when the inbound reservation scheduling message 318 is transported in the first inbound reservation scheduling slot 216. Similarly, when a subscriber access code of a subscriber radio 104 is stored in the first subscriber access code field 300 and the first adjacent slot bit 306 is set, then that subscriber radio 104 may transmit during the fourth, fifth and sixth inbound transmission slots 205-207 when the inbound reservation scheduling message 318 is transported in the second inbound reservation scheduling slot 218.

In yet another embodiment, the adjacent slot bit may indicate whether the subscriber radio 104 may also transmit data during one or more inbound transmission slots 202-213 that are not immediately adjacent to the inbound transmission slot 202-213 corresponding with the subscriber access code field 300-305.

By utilizing the adjacent slot bits 306-311, the disclosed system 100 and methods allow for multiple inbound transmission slot 202-213 assignments without repeating the subscriber access code over multiple subscriber access code fields 300-305.

Each inbound reservation scheduling message 318 may further include number of superframes fields 312-317. Each number of superframes field 312-317 is associated with one of the subscriber access code fields 300-305. Specifically, in the illustrated embodiment, a first number of superframes field 312 is associated with the first subscriber access code field 300, a second number of superframes field 313 is associated with the second subscriber access code field 301, a third number of superframes field 314 is associated with the third subscriber access code field 302, a fourth number of superframes field 315 is associated with the fourth subscriber access code field 303, a fifth number of superframes field 316 is associated with the fifth subscriber access code field 304, and a sixth number of superframes field 317 is associated with the sixth subscriber access code field 305.

Each number of superframes field 312-317 indicates a number of superframes for which the inbound transmission slot may be utilized by the subscriber radio 104 associated with the subscriber access code field 300-305. For example, when a subscriber access code of a subscriber radio 104 is stored in the third subscriber access code field 302 of the inbound reservation scheduling message 318 transported in the first inbound reservation scheduling slot 216A of the first superframe 200A, and the number “3” is stored in the third number of superframes field 314, then the subscriber radio 104 may transmit during the eighth inbound slots 209A, 209B, 209C of the first, second, and third superframes 300A, 300B, 300C.

By utilizing the number of superframes field 312-317, the system 100 and method may assign multiple inbound transmission slots 202-213 in one data burst from the base station. As such, the subscriber radio 104 may utilize the assigned inbound transmission slot 202-213, even if future assignments from the base station are missed by the subscriber radio 104.

In the illustrated embodiment, each number of superframes field 312-317 has a length of three bits. As such, up to eight consecutive superframes may be authorized for the subscriber radio 104 to transmit during the associated inbound slot 202-213. Of course, in other embodiments, the length of the number of superframes fields 312-317 may be longer or shorter.

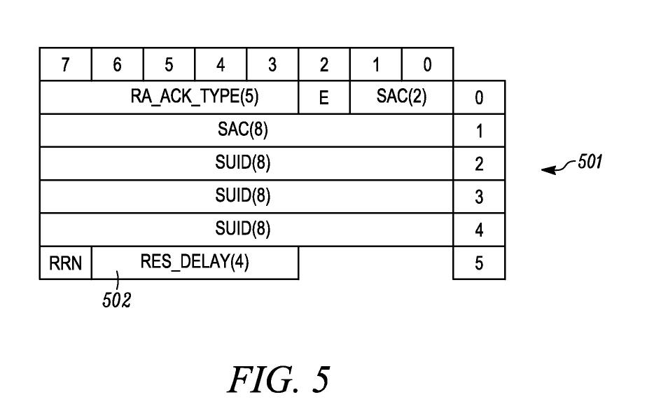

As briefly discussed above, a subscriber radio 104 may transmit during an inbound random access slot to begin the process of reserving inbound reserved access slots 201. The base station 102 then transmits at least one reservation request response 501, as shown in FIG. 5. The reservation request response 501 of the illustrated embodiment includes a subscriber access code, the full 24-bit subscriber address, and a reservation delay value 502. The reservation delay value 502 indicates an amount of time that will pass before the slot assignment is sent. Specifically, in the illustrated embodiment, the reservation delay value 502 provides a number of super frames (or number of slots) that will occur before the slot assignment is sent. The reservation delay value 502 is utilized to allow the base station 102 to take into account other subscriber radios 104 requests. The subscriber radio 104, which now knows how long until the slot assignment is sent, may refresh data or perform other “housekeeping” duties. As an example of a “housekeeping” duty, the subscriber radio 104 may return to the outbound control channel to listen if there is an announcement of a group call relevant to the given subscriber radio 104. If there is a group voice call relevant to the given subscriber radio 104, the subscriber radio 104 may tune to the specified voice channel to receive the voice call. Because the EDC channels, voice channels and control channels are synchronized, and because the subscriber radio 104 knows the exact time it must return to the EDC channel for its reservation (i.e., the inbound reservation slot 202-213) the subscriber radio 104 may stay tuned to the outbound control channel or outbound voice channel and know when to leave the control channel or voice channel to arrive within microseconds of the precise time to transmit on its inbound reservation slot 202-213 on the EDC channel.

Furthermore, if the reservation delay value 502 is greater than or equal to 15 superframes, then the subscriber radio 102 may return to the control channel or make another random access request.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method of assigning slot reservations to subscriber radios in a time division multiple access (TDMA) communications system, wherein transmission of data is arranged into a series of superframes, said method comprising:
providing an inbound signaling protocol transported in a plurality of inbound transmission slots;
providing an outbound signaling protocol having an inbound reservation scheduling message, the inbound reservation scheduling message including a plurality of subscriber access code fields, each subscriber access code field corresponding to at least one of the plurality of inbound transmission slots, and each subscriber access code field able to store a subscriber access code associated with a subscriber radio; and
transmitting the inbound reservation scheduling message within an inbound reservation scheduling slot including a subscriber access code in at least one of the subscriber access code fields such that the subscriber radio associated with the subscriber access code may transmit data during at least one of the inbound transmission slots corresponding to the subscriber access code field in which the subscriber access code is stored.

2. A method as set forth in claim 1 wherein at least one of the subscriber access code fields correspond to inbound transmission slots in a first superframe and at least one of the subscriber access code fields correspond to inbound transmission slots in a second superframe, to be transmitted after the first superframe.

3. A method as set forth in claim 1 further comprising associating a subset of the inbound transmission slots with either a first logical channel or a second logical channel.

4. A method as set forth in claim 3 wherein providing an outbound signaling protocol further includes having a first inbound reservation scheduling message associated with the first logical channel and a second inbound reservation scheduling message associated with the second logical channel, each inbound reservation scheduling message including a plurality of subscriber access code fields, each subscriber access code field corresponding to at least one of the plurality of inbound transmission slots, and each subscriber access code field able to store a subscriber access code associated with a subscriber radio.

5. A method as set forth in claim 4 wherein the outbound signaling protocol further includes an adjacent slot bit associated with each subscriber access code field indicating whether the subscriber radio may also transmit data during the inbound transmission slot adjacent to the inbound transmission slot corresponding with the subscriber access code field.

6. A method as set forth in claim 1 wherein the outbound signaling protocol further includes a superframes field associated with each subscriber access code field indicating a number of superframes for which the inbound transmission slot may be utilized by the subscriber radio associated with the subscriber access code field.

7. A method as set forth in claim 1 further comprising transmitting a reservation delay value prior to transmitting the inbound reservation scheduling message, the reservation delay value indicating an amount of time that will pass before the inbound reservation scheduling message is transmitted.

8. A method of operating a time division multiple access (TDMA) communications system having a base station and at least one subscriber radio, wherein encoded data is arranged into a series of superframes, said method comprising:
receiving data in accordance with an inbound signaling protocol transported in a plurality of inbound transmission slots;
transmitting data in accordance with an outbound signaling protocol having an inbound reservation scheduling message, the inbound reservation scheduling message including a plurality of subscriber access code fields, each subscriber access code field corresponding to at least one of the plurality of inbound transmission slots, and each subscriber access code field able to store a subscriber access code associated with a subscriber radio; and
transmitting the inbound reservation scheduling message during an inbound reservation scheduling slot including a subscriber access code in at least one of the subscriber access code fields such that the subscriber radio associated with the subscriber access code may transmit data during the at least one of the plurality of inbound transmission slots corresponding to the subscriber access code field in which the subscriber access code is stored.

9. A method as set forth in claim 8 wherein at least one of the subscriber access code fields correspond to inbound transmission slots in a first superframe and at least one of the subscriber access code fields correspond to inbound transmission slots in a second superframe, to be transmitted after the first superframe.

10. A method as set forth in claim 8 further comprising associating a subset of the inbound transmission slots with either a first logical channel or a second logical channel.

11. A method as set forth in claim 10 wherein providing an outbound signaling protocol is further defined as providing an outbound signaling protocol having a first inbound reservation scheduling message associated with the first logical channel and a second inbound reservation scheduling message associated with the second logical channel, each inbound reservation scheduling message including a plurality of subscriber access code fields, each subscriber access code field corresponding to one of the plurality of inbound transmission slots, and each subscriber access code field able to store a subscriber access code associated with a subscriber radio.

12. A method as set forth in claim 11 wherein the outbound signaling protocol further includes an adjacent slot bit associated with each subscriber access code field indicating whether the subscriber radio may also transmit data during the inbound transmission slot adjacent to the inbound transmission slot corresponding with the subscriber access code field.

13. A method as set forth in claim 8 wherein the outbound signaling protocol further includes a superframes field associated with each subscriber access code field indicating a number of superframes for which the inbound transmission slot may be utilized by the subscriber radio associated with the subscriber access code field.

14. A method as set forth in claim 8 further comprising transmitting a reservation delay value prior to transmitting the inbound reservation scheduling message, the reservation delay value indicating an amount of time that will pass before the inbound reservation scheduling message is transmitted.

15. A time division multiple access (TDMA) communications system wherein transmission of data is arranged into a series of superframes, said system comprising:
a controller capable of receiving an inbound signaling protocol transported in a plurality of inbound transmission slots and providing an outbound signaling protocol having an inbound reservation scheduling message, the inbound reservation scheduling message including a plurality of subscriber access code fields, each subscriber access code field corresponding to at least one of the plurality of inbound transmission slots, and each subscriber access code field able to store a subscriber access code associated with a subscriber radio; and
a transmitter in communication with said controller for transmitting the inbound reservation scheduling message during an inbound reservation scheduling slot including a subscriber access code in at least one of the subscriber access code fields such that the subscriber radio associated with the subscriber access code may transmit data during at least one of the inbound transmission slots corresponding to the subscriber access code field in which the subscriber access code is stored.

16. A system as set forth in claim 15 wherein at least one of the subscriber access code fields correspond to inbound transmission slots in a first superframe and at least one of the subscriber access code fields correspond to inbound transmission slots in a second superframe, to be transmitted after the first superframe.

17. A system as set forth in claim 15 wherein a subset of the inbound transmission slots are associated with either a first logical channel or a second logical channel.

18. A system as set forth in claim 17 wherein providing an outbound signaling protocol is further defined as providing an outbound signaling protocol having a first inbound reservation scheduling message associated with the first logical channel and a second inbound reservation scheduling message associated with the second logical channel, each inbound reservation scheduling message including a plurality of subscriber access code fields, each subscriber access code field corresponding to one of the plurality of inbound transmission slots, and each subscriber access code field able to store a subscriber access code associated with the subscriber radio.

19. A system as set forth in claim 17 wherein the outbound signaling protocol further includes an adjacent slot bit associated with each subscriber access code field indicating whether the subscriber radio may also transmit data during the inbound transmission slot adjacent to the inbound transmission slot corresponding with the subscriber access code field.

20. A system as set forth in claim 18 wherein the outbound signaling protocol further includes a number of superframes field associated with each subscriber access code field indicating a number of superframes for which the inbound transmission slot may be utilized by the subscriber radio associated with the subscriber access code field.
